(19) United States
(12) Patent Application Publication
(10) Pub. No.: US 2025/0111639 A1
(43) Pub. Date: Apr. 3, 2025

(54) METHOD FOR DETECTING OBJECT AND METHOD FOR ESTIMATING DISTANCES OF OBJECT IN IMAGE AND HOST AND SYSTEM THEREOF

(71) Applicant: AutoSys (TW) Co., Ltd., Hsinchu County (TW)

(72) Inventors: Jun-Yao Zhong, SURABAYA (ID); Bo-Yu Chen, Hsinchu County (TW); Jui-Li Chen, Hsinchu County (TW); Tse-Min Chen, Hsinchu County (TW)

(21) Appl. No.: 18/823,643

(22) Filed: Sep. 3, 2024

(30) Foreign Application Priority Data
Sep. 28, 2023 (TW) 112137553

(51) Int. Cl. G06V 10/25; G06T 5/10; G06T 5/20; G06V 10/44

(52) U.S. Cl. CPC G06V 10/25; G06T 5/10; G06T 5/20; G06V 10/44; G06T 2207/20084; G06V 2201/07

(57) ABSTRACT

This invention provides a method for detecting object, which comprises receiving an image; and executing a deep neural network architecture for the image to obtain one or more object bounding box, wherein the deep neural network architecture comprises a two-dimensional discrete wavelet transform.

### CROSS-REFERENCE TO RELATED APPLICATIONS

This non-provisional application claims priority claim under 35 U.S.C. § 119 (a) on Taiwan Patent Application No. 112137553 filed Sep. 28, 2023, the entire contents of which are incorporated herein by reference.

### TECHNICAL FIELD

This invention relates to a method for estimating distance of object in image, and more particular a method for estimating distance of object in image using a single deep neural network architecture.

### BACKGROUND

Intelligent vehicles need to estimate distances for navigation and driving. Current distance estimation methods typically use active ranging instruments such as millimeter wave radar, laser radar, and LiDAR. Although these active ranging instruments have advantages such as high resolution, strong anti-interference capabilities, minimal impact from weather conditions, high-speed detection, and non-contact performance, they are quite expensive and pose issues related to radiation and electromagnetic interference during use. Therefore, using these active ranging instruments on intelligent vehicles not only increases costs but also raises challenges related to electromagnetic compatibility certification and electromagnetic spectrum licensing.

Another passive ranging method is estimating the distance of objects using images captured by cameras. Under conditions of slow network speed, in order to achieve real-time performance, the on-board computer of the intelligent vehicle must first use a deep neural network architecture to detect objects, and then estimate the distance of the objects through the image settings and the bounding box position of the objects. However, the computing resources of the on-board computer of the intelligent vehicle are usually limited, and the computational load of the deep neural network architecture used must be lightweight.

Due to the limitations of current deep neural network architectures, the object bounding boxes cannot adapt to the size of objects in each frame, resulting in instability in the size of the object bounding boxes detected by lightweight deep neural network architecture. Since distance estimation is based on the size of these object bounding boxes, if the size of an object in one frame differs significantly from its size in the next frame, the estimated distance will exhibit large fluctuations and variations, thereby increasing the estimation error. When the vehicle has significant errors in estimating the distance to surrounding objects, navigation and driving computations become increasingly challenging.

Therefore, there is an urgent need for a deep neural network architecture that maintains the same lightweight computational requirements but does not require extensive computational resources, making it easier to run on the onboard computer of the intelligent vehicle. This deep neural network architecture should be capable of stabilizing the size of object bounding boxes. By ensuring stable sizes of the object bounding boxes, more accurate and stable distance estimation can be achieved, which would benefit the navigation and driving of intelligent vehicles.

### SUMMARY

According to an embodiment of the invention, an object detection method is provided, comprising: receiving an image; and executing a deep neural network architecture based on the image to obtain one or more object bounding boxes, wherein the deep neural network architecture includes a two-dimensional discrete wavelet transform. Preferably, to integrate information from deep and shallow networks, the deep neural network architecture comprises: a backbone network, comprising the two-dimensional discrete wavelet transform; a neck network, comprising a feature pyramid network, and configured to extract features from a transformation result of the two-dimensional discrete wavelet transform in the backbone network; and a detection head, configured to obtain the one or more object bounding boxes of one or more objects from the neck network.

Preferably, to detect objects of different scales, the detection head includes a large object detection head, a medium object detection head, and a small object detection head, each configured to obtain the one or more object bounding boxes from multiple chunks of different sizes in the neck network.

Preferably, to enhance the information of object edges or features, wherein the transformation result of the two-dimensional discrete wavelet transform includes a sum result of at least two of three results obtained by filtering with a high-pass filter of the two-dimensional discrete wavelet transform.

Preferably, to preserve the information of the original image, wherein the transformation result of the two-dimensional discrete wavelet transform comprises a concatenated result of the sum result and a result obtained without filtering by the high-pass filter of the two-dimensional discrete wavelet transform.

Preferably, to utilize a convolutional neural network for feature extraction, wherein the backbone network includes a convolutional neural network configured to obtain a convolution result, and the neck network includes a feature extraction result obtained by concatenating the transformation result with the convolution result from the backbone network.

According to an embodiment of the invention, a method for estimating distances of object using images is provided, comprising: performing the aforementioned object detection method; and using the one or more object bounding boxes and a corresponding parameter of the image to estimate a distance between one or more objects corresponding to the one or more object bounding boxes and a camera device that captured the image.

Preferably, to simplify the linear transformation for distance calculation, wherein the corresponding parameter of the image include a homography matrix, used to map one or more positions presented in the image to a ground.

According to an embodiment of the invention, a host for object detection is provided, comprising: one or more processors configured to execute multiple computer instructions stored in a non-volatile memory to implement the object detection method described above.

According to an embodiment of the present invention, a system for estimating distances of object using images is provided, comprising: a host including one or more processors configured to execute multiple computer instructions stored in a non-volatile memory to implement the method for estimating distances of the object using images as described above; and the camera device as described above.

According to the object detection method, method for estimating object distance from images, and its host and system provided by this invention, objects can be detected based on images, and the object bounding box can be stabilized, which enables more accurate distance estimation in post-processing. The feature of the invention lies in the provided deep neural network architecture that includes discrete wavelet transform, which can enhance object edges and features. Combined with the pyramid network as the feature neck network architecture, it can fuse the features presented by deep and shallow networks, enhance the object detection ability, and improve the complexity of the architecture, so that it does not require too many layers to achieve stable and accurate object bounding box detection, and also provides a faster inference time.

### BRIEF DESCRIPTION OF THE DRAWINGS

FIG. 1 is a block diagram of a deep neural network architecture according to an embodiment of the invention.

FIG. 2 is a block diagram of the deep neural network architecture according to another embodiment of the invention.

FIG. 3 is a block diagram of a two-dimensional discrete wavelet transform.

FIG. 4 is a flowchart of the two-dimensional discrete wavelet transform method.

FIG. 5 is a flowchart of the discrete wavelet transform convolutional neural network according to an embodiment of the invention.

FIG. 6 is a schematic diagram of the neck network according to an embodiment of the invention.

FIG. 7A and FIG. 7B are the four object detection output results processed by the deep neural network architecture according to an embodiment of the invention.

FIG. 8 is an example of a homography matrix H-Matrix according to an embodiment of the invention.

FIG. 9 is a flowchart of a method for estimating object distance using images according to an embodiment of the invention.

FIG. 10 is a block diagram of a system for distance estimation using images in an embodiment of the invention.

### DETAILED DESCRIPTION

To make the objectives, technical solutions, and advantages of this application clearer, a detailed description of the technical solutions will be provided below. The described embodiments are only a part of the embodiments of this invention and not all of them. Based on the embodiments in this invention, any other embodiments obtained by those skilled in the art without making creative efforts fall within the scope of protection of this invention.

The terms “first,” “second,” “third,” etc. (if present), in the description and claims of this invention, as well as in the drawings, are used to distinguish similar objects and are not meant to describe a particular order or sequence. It should be understood that the objects described above can be interchanged as appropriate. In the description of this invention, the term “plurality” means two or more, unless otherwise explicitly defined. Furthermore, the terms “comprising” and “having,” as well as any variations thereof, are intended to cover non-exclusive inclusion. Some of the block diagrams shown in the drawings represent functional entities and do not necessarily correspond to physically or logically independent entities. These functional entities may be implemented in the form of software, or in one or more hardware circuits or integrated circuits, or in different networks and/or processor devices and/or microcontroller devices.

In the description of this invention, it should be noted that, unless otherwise explicitly specified and limited, the terms “installation,” “connected,” and “coupled” should be understood in a broad sense. For example, they may refer to fixed connections, removable connections, or integral connections. They may be mechanical connections, electrical connections, or communications between entities. They may be directly connected or indirectly connected through intermediaries, and may refer to the internal communication within two components or the interaction between two components. Those skilled in the art can understand the specific meanings of these terms in this invention based on the specific context.

To make the objectives, features, and advantages of this invention more apparent and understandable, a further detailed explanation of this invention will be provided below in conjunction with the drawings and specific embodiments.

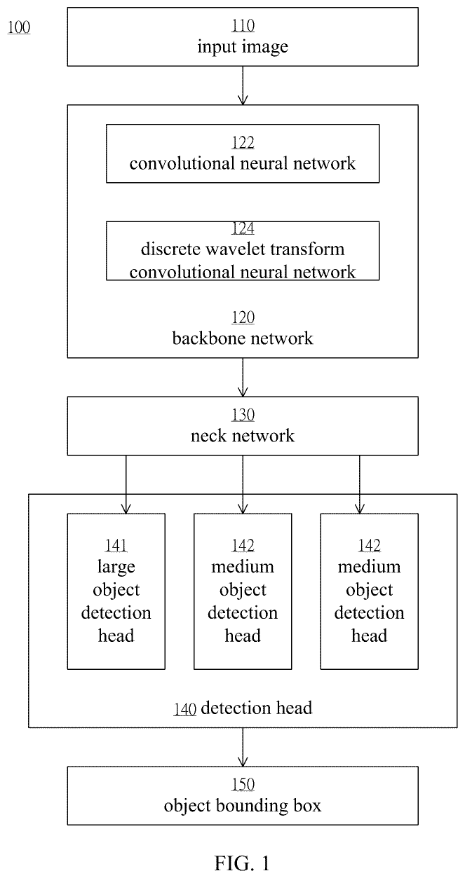

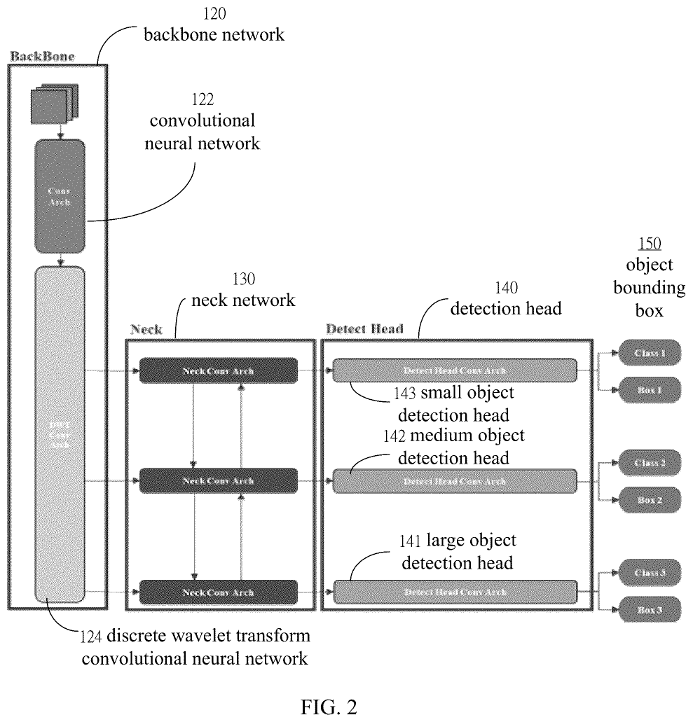

Please referring to FIG. 1, is a block diagram of a deep neural network architecture according to an embodiment of the invention. Also referring to FIG. 2, is a block diagram of the deep neural network architecture according to another embodiment of the invention. The deep neural network architecture 100 includes a three-layer deep neural network, such as a backbone network 120, a neck network 130 and at least one detection head 140. The backbone network 120 is used to receive an input image 110. The neck network 130 is used to extract features of the image transmitted from the backbone network 120. Finally, the detection head 140 is used to obtain the bounding boxes of the objects of interest from the image of the neck network 130. The output of the deep neural network architecture 100 is the bounding boxes of the objects of the desired detection categories.

The input image 110 may come from a camera or imaging device, which may output multi-spectral images. For example, the input image 110 may be encoded in the three primary colors: red, green, and blue. However, those skilled in the art will understand that the camera may output single-spectral images, such as those encoded in infrared, ultraviolet, or grayscale.

When the characteristics of the camera lens are known, the distance between the objects captured in the input image 110 and the camera lens can be determined based on these characteristics. In other words, the distance of the captured objects can be estimated using the input image 110. The role of the deep neural network architecture 100 is to stabilize the size of the bounding boxes of the detected object to facilitate accurate distance estimation.

The backbone network 120 may include two layers of neural networks. The first layer may be a convolutional neural network (CNN) 122 or a variation thereof, which is referred to as a convolutional neural network. The second layer may be a neural network that combines discrete wavelet transform (DWT) with convolutional neural networks, which is one of the features of the invention. A detailed description of the second layer will be provided later in this application.

The backbone network 120 performs multiple down-sampling operations on image, and outputs the down-sampled images to the neck network 130 for feature extraction. Finally, the extracted features are passed to the detection head 140 from the neck network 130. In one embodiment, the neck network 130 may include a Feature Pyramid Network (FPN) combined with a Pyramid Attention Network (PAN), enabling the exchange of information between deep and shallow layers within the architecture. In another embodiment, the neck network 130 may combine a Spatial Pyramid Pooling layer (SPP) with a Path Aggregation Network (PANet).

As shown in FIG. 1 and FIG. 2, the detection head 140 may include three separate detection head branches, each corresponding to a different level of the pyramid in the neck network 130 for detecting large, medium, and small objects. In each individual detection head 141, 142, and 143, the image is divided into multiple chunks, and each chunk contains several anchor boxes. The detection heads 141, 142, and 143 can predict the offsets between the target objects and the anchor boxes. Each anchor box can predict one or more bounding boxes, and finally, bounding boxes with low confidence scores are discarded.

To enhance the stability of object bounding boxes, this invention incorporates discrete wavelet transform (DWT) into the backbone network 120 to enhance the high-frequency components of the input image 110. Since high-frequency components typically represent the edges and features of objects, enhancing them can reduce the likelihood of the connected neck network 130 missing high-frequency object edges or features during deep, middle, and shallow feature extraction. In other words, the detection head 140 can more consistently and accurately mark the bounding boxes corresponding to the objects of interest.

When the size of the bounding box corresponding to the same object in consecutive images does not suddenly change, the reliability of the measured distance will be increased, which is beneficial for navigation and autonomous driving. For example, in a vehicle equipped with the deep neural network architecture 100 provided by this invention, the bounding box size of the preceding vehicle will not fluctuate drastically. This stability ensures that the distance to the preceding vehicle, as perceived by the adaptive cruise control system, does not suddenly change significantly, reducing instances of abrupt acceleration or deceleration to adjust to distance changes. Consequently, this can lead to reduced fuel consumption, less brake wear, enhanced safety, and improved passenger comfort.

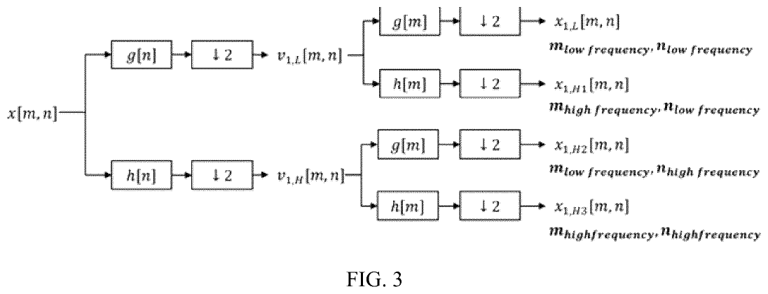

Please referring to FIG. 3, shows a block diagram of a two-dimensional discrete wavelet transform. The input signal x[m,n] is a two-dimensional array x, with m being the first dimension and n being the second dimension. A second dimension low-pass filter g[n] is used to transform the second dimension of the input signal x[m,n], filtering out the high-frequency components and retaining the low-frequency components. Conversely, a second dimension high-pass filter h[n] is used to transform the second dimension, filtering out the low-frequency components and retaining the high-frequency components. After passing through g[n] and h[n], down-sampling is performed (e.g., down-sampling by 2), resulting in a second dimension low-frequency part v_{1,L}[m,n], and a second dimension high-frequency part, V_{1,H}[m,n].

Next, the previously obtained second dimension low-frequency part v_{1,L}[m,n] and second dimension high-frequency part v_{1,H}[m,n] are respectively filtered again using the first dimension low-pass filter g[m] and the first dimension high-pass filter h[m], followed by down-sampling by a factor of 2. This process yields four parts. As shown in FIG. 3 from top to bottom, we obtain the low-frequency components in both the first and second dimensions X_{1,LL}, the high-frequency components in the first dimension and low-frequency components in the second dimension X_{1,HL}, the low-frequency components in the first dimension and high-frequency components in the second dimension X_{1,LH}, and the high-frequency components in both the first and second dimensions X_{1,HH}.

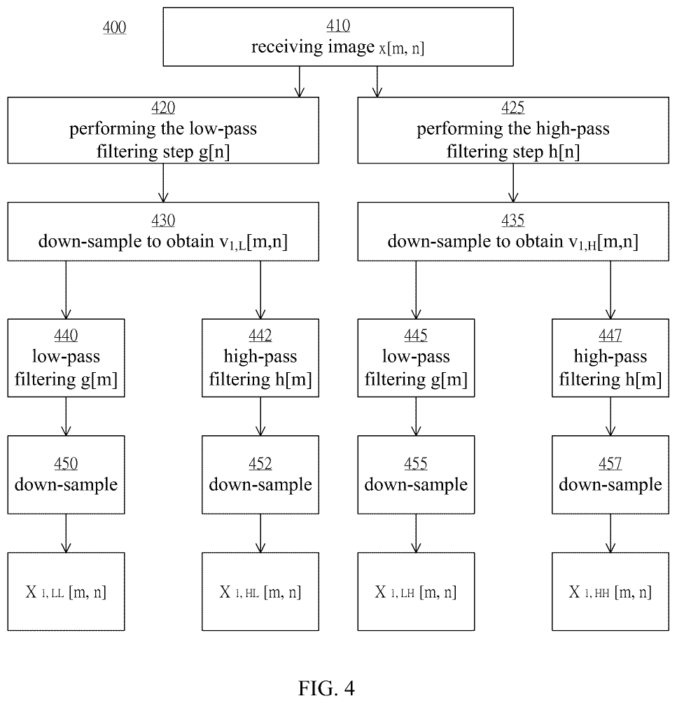

Please referring to FIG. 4, is a flowchart of the two-dimensional discrete wavelet transform method 400. This flow chart may start from step 410. When there is no direct or indirect causal relationship between any two steps, this invention does not limit the order in which they are executed.

Step 410: Receive the two-dimensional image x[m,n].

Step 420: Perform the low-pass filtering step g[n] on the received image x[m,n] along the second dimension.

Step 425: Perform the high-pass filtering step h[n] on the received image x[m,n] along the second dimension.

Step 430: Down-sample the result obtained from step 420 by a factor of 2 to obtain v_{1,L}[m,n].

Step 435: Down-sample the result obtained from step 425 by a factor of 2 to obtain V_{1,H}[m,n].

Step 440: Perform the low-pass filtering step g[m] on the received image V_{1,L}[m,n] along the first dimension.

Step 442: Perform the high-pass filtering step h[m] on the received image V_{1,L}[m,n] along the first dimension.

Step 445: Perform the low-pass filtering step g[m] on the received image V_{1,H}[m,n] along the first dimension.

Step 447: Perform the high-pass filtering step h[m] on the received image V_{1,H}[m,n] along the first dimension.

Step 450: Down-sample the result obtained from step 440 by a factor of 2 to obtain X_{1,LL}[m,n], which is the low-frequency component in both the first and second dimensions.

Step 452: Down-sample the result obtained from step 442 by a factor of 2 to obtain X_{1,HL}[m,n], which is the high-frequency component in the first dimension and low-frequency component in the second dimension.

Step 455: Down-sample the result obtained from step 445 by a factor of 2 to obtain X_{1,LH}[m,n], which is the low-frequency component in the first dimension and high-frequency component in the second dimension.

Step 457: Down-sample the result obtained from step 447 by a factor of 2 to obtain X_{1,HH}[m,n], which is the high-frequency component in both the first and second dimensions.

The discrete wavelet transforms illustrated in FIG. 3 and FIG. 4 can be applied in the discrete wavelet transform convolutional neural network 124 to perform discrete wavelet transform on the image signal processed by the convolutional neural network 122. Those skilled in the art will understand that, although the discrete wavelet transform process depicted in FIG. 3 and FIG. 4 first performs filtering along the second dimension and then along the first dimension, in an alternative embodiment, filtering could be performed first along the first dimension and then along the second dimension

Please refer to the six equations in Table 1 for the discrete wavelet transform.

TABLE 1
Discrete Wavelet Transform Equations.

| | |
|---|---|
| ${v}_{1 , L} [ x , y ] = {\sum }_{k = 0}^{K - 1} image [ x , 2 y - k ] g [ k ]$ | (1) |
| ${v}_{1 , H} [ x , y ] = {\sum }_{k = 0}^{K - 1} image [ x , 2 y - k ] h [ k ]$ | (2) |
| ${v}_{1 , L L} [ x , y ] = {\sum }_{k = 0}^{K - 1} {v}_{1 , L} [ 2 x - k , y ] g [ k ]$ | (3) |
| ${v}_{1 , H L} [ x , y ] = {\sum }_{k = 0}^{K - 1} {v}_{1 , L} [ 2 x - k , y ] h [ k ]$ | (4) |
| ${v}_{1 , LH} [ x , y ] = {\sum }_{k = 0}^{K - 1} {v}_{1 , H} [ 2 x - k , y ] g [ k ]$ | (5) |
| ${v}_{1 , HH} [ x , y ] = {\sum }_{k = 0}^{K - 1} {v}_{1 , H} [ 2 x - k , y ] h [ k ]$ | (6) |

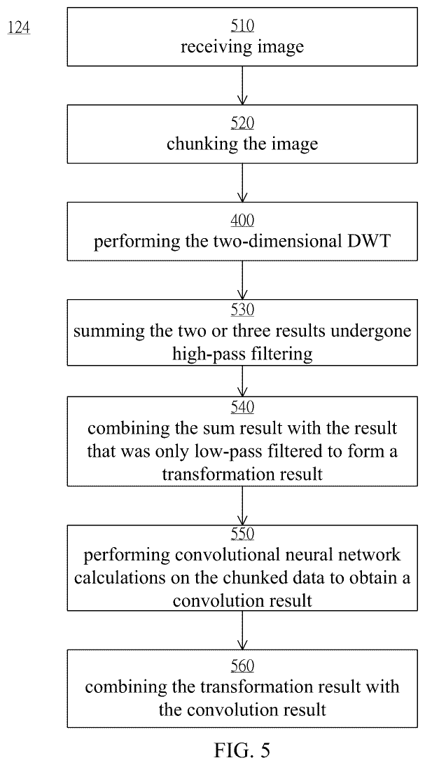

Please referring to FIG. 5, is a flowchart of the discrete wavelet transform convolutional neural network 124 according to an embodiment of the invention. The implementation of the discrete wavelet transform convolutional neural network 124 may include the following steps.

Step 510: Receive the input image. As mentioned above, the input image received in this step may be the image signal processed by the convolutional neural network 122.

Step 520: Chunk the received input image. Next, proceed to step 400, which is the two-dimensional discrete wavelet transform shown in FIG. 3 or FIG. 4. After performing the two-dimensional discrete wavelet transform, four results will be obtained. The process then proceeds to step 530.

Step 530: Sum the two or three results obtained after high-pass filtering. As mentioned previously, except for the low-frequency component in both dimensions X_{1,LL} obtained from step 450 or equation (3), the remaining three component have been filtered by at least one high-pass filter. In this step, any two of these components can be summed, or all three can be summed to form a sum result. For example, the three results obtained from steps 452, 455, and 457 can be summed, or any two of these can be summed.

Step 540: Combine the sum result from step 530 with the result that was only low-pass filtered (the low-frequency component in both dimensions X_{1,LL}) to form a transformation result. Then, proceed to step 550.

Step 550: Perform convolutional neural network calculations on the chunked data obtained in step 520 to obtain a convolution result. Since step 550 is not causally related to the two-dimensional discrete wavelet transform steps 400, step 530, and step 540, this invention does not limit the order of execution between step 550 and the aforementioned discrete wavelet transform steps.

Step 560: Combine the transformation result from step 540 with the convolution result from step 550. Next, the neck network 130 performs feature extraction on the results processed by the discrete wavelet transform convolutional neural network 124 to form a feature extraction result.

The backbone network 120 of the invention incorporates the discrete wavelet transform. Since the discrete wavelet transform involves dimensionality reduction (down-sampling) and can separate different frequency domains of two-dimensional image signals, the discrete wavelet transform convolutional neural network 124 shown in FIG. 5 has the capability of dimensionality reduction. This enables enhanced information about object edges or features during feature extraction, resulting in more diverse features for the backbone network 120 to process.

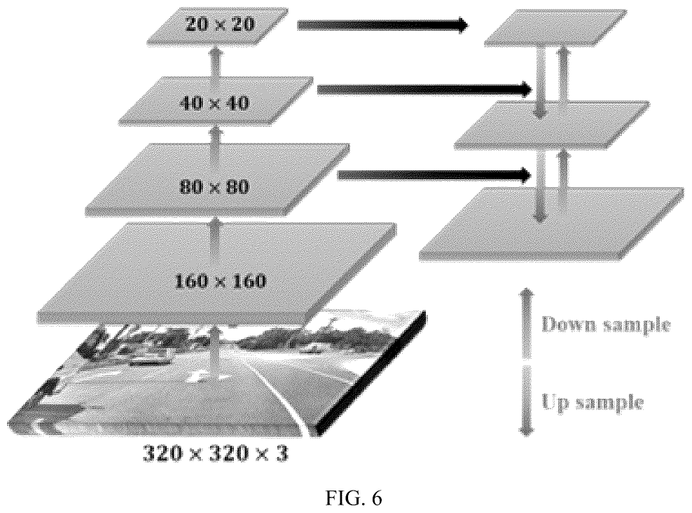

Please referring to FIG. 6, shows a schematic diagram of the neck network according to an embodiment of the invention. When processing information from the backbone network 120, different-sized images can be obtained through down-sampling. For example, information with a 320×320 pixel array can be down-sampled multiple times to obtain pixel arrays of 160×160, 80×80, 40×40, and 20×20, respectively. Feature extraction can be performed on each pixel array of different sizes to obtain information from both shallow and deep network information.

Next, through the steps of up-sampling and down-sampling, shallow and deep network information are fused to enhance the localization capability across multiple scales. As shown in FIG. 1 and FIG. 2, the detection heads 140 following the neck network 130 may include a large object detection head 141, a medium object detection head 142, and a small object detection head 143. These detection heads can perform object detection across various scales. FIG. 6 represents just one example of the invention, and those skilled in the art are able to understand that this invention can use various implementations of the neck network 130. As long as the neck network 130 utilizes a pyramid-type network structure, it can be considered an embodiment of this invention.

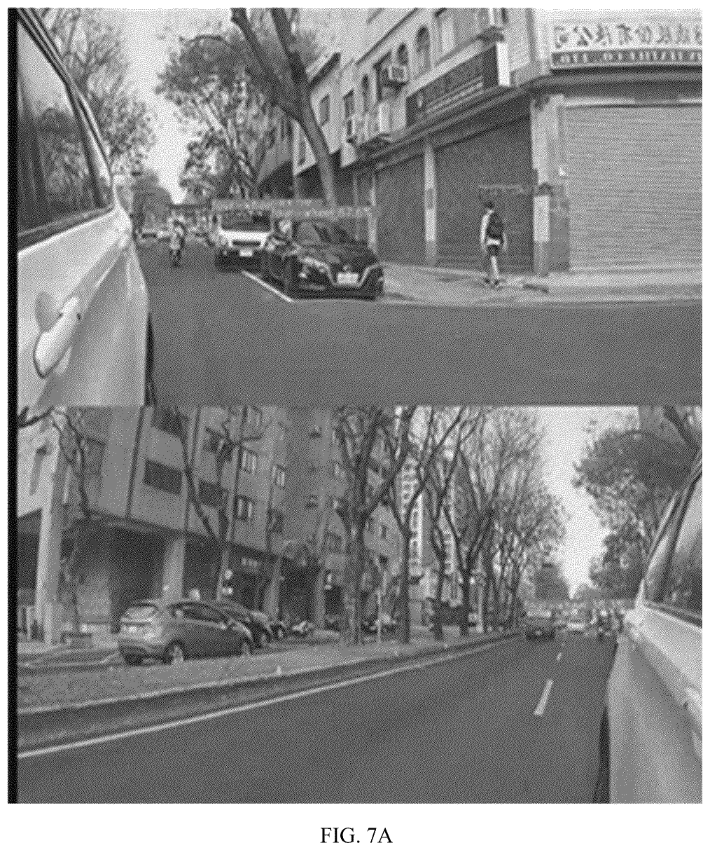

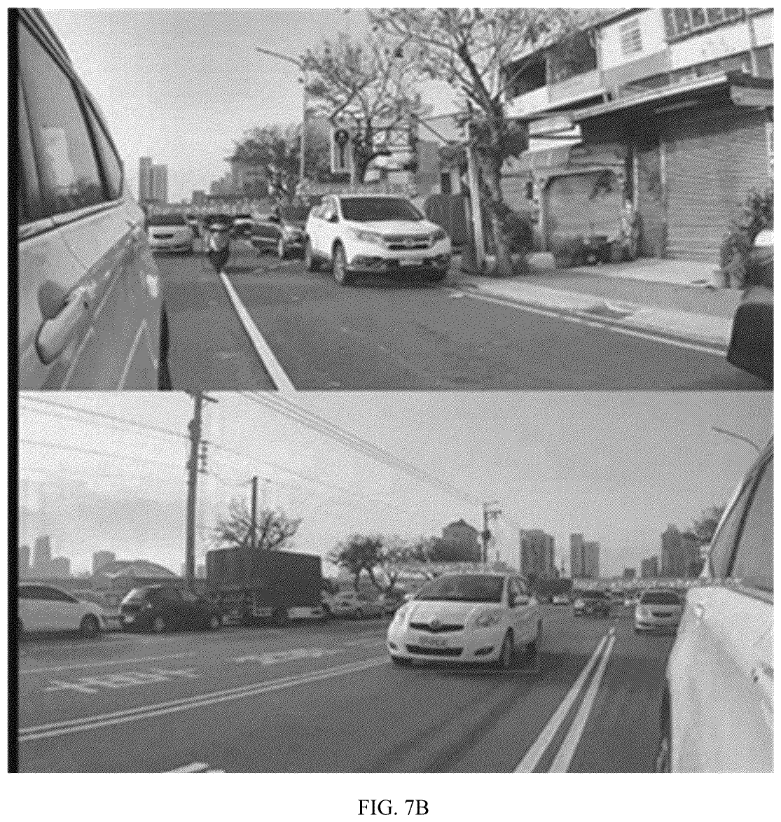

Please referring to FIG. 7A and FIG. 7B, show the four object detection output results processed by the deep neural network architecture according to an embodiment of the invention. In these four processed images, bounding boxes for objects of pedestrians, cars, and motorcycles can be seen. These three types of objects are the object categories to be detected in this embodiment. Those skilled in the art will understand that the deep neural network architecture 100 can detect different types of objects.

As previously mentioned, one of the objectives of this invention is to utilize images to detect the distance of object. In one embodiment of the invention, a homography matrix may be applied to project the image from one plane to another. The parameters of the homography matrix can be set according to the characteristics of the aforementioned camera lens.

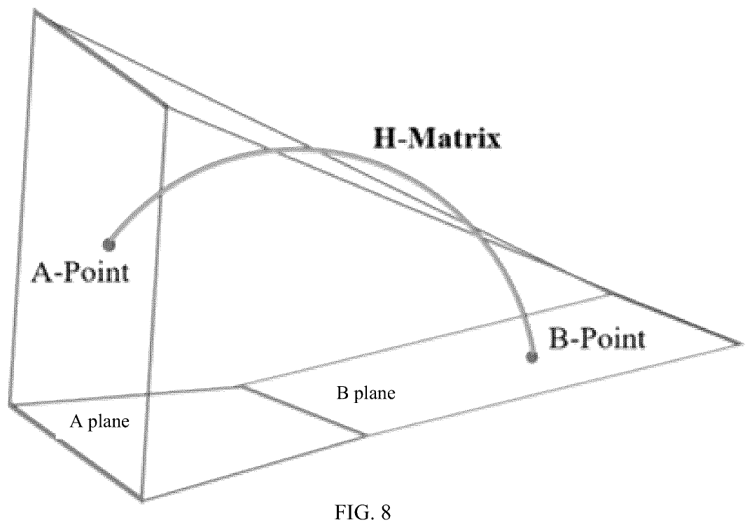

Please referring to FIG. 8, illustrates an example of a homography matrix H-Matrix according to an embodiment of the invention. As shown in FIG. 8, when a camera lens captures the B plane, it converts the B plane into an image on the A plane. To convert the coordinates (x, y) of a point A on the A plane to coordinates (u, v) of a point B on the B plane, the corresponding homography matrix H-Matrix of the camera lens can be used for the transformation.

In one embodiment, the B plane may be considered as the ground, and the A plane may be considered as the imaging plane of the camera. Since the parameters of the homography matrix (H-Matrix) of the camera are pre-measured, the coordinates of point A in the A plane image can be transformed into the coordinates of point B in the B plane. Furthermore, the relationship between plane A and plane B is known. When plane B is the ground, the distance between point B and the camera can be determined. For example, in the bounding boxes of various objects shown in FIG. 7A and FIG. 7B, the midpoint of the lower edge of the bounding box can be regarded as point A. By using the homography matrix (H-Matrix) for transformation, the distance between the object and the camera can be obtained.

Thus, one of the objectives pursued by this invention is the stabilization of bounding box sizes, as the bounding box is related to the estimation of the object's distance. Please referring to Table 2, details a method for calculating the homography matrix.

TABLE 2
Homography Matrix Calculation Formulas

| | |
|---|---|
| $[ \begin{matrix}u \\ v \\ 1\end{matrix} ] = [ \begin{matrix}{h}_{11} & {h}_{12} & {h}_{13} \\ {h}_{21} & {h}_{22} & {h}_{23} \\ {h}_{31} & {h}_{32} & 1\end{matrix} ] [ \begin{matrix}x \\ y \\ 1\end{matrix} ]$ | (7) |
| $u = \frac{{h}_{11} x + {h}_{12} y + {h}_{13}}{{h}_{31} x + {h}_{32} y + 1}$ | (8) |
| $v = \frac{{h}_{21} x + {h}_{22} y + {h}_{23}}{{h}_{31} x + {h}_{32} y + 1}$ | (9) |
| 1 = h₃₁x + h₃₂y + 1 | (10) |
| h₁₁x + h₁₂y + h₁₃ − h₃₁ux − h₃₂uy − u = 0 | (11) |
| h₂₁x + h₂₂y + h₂₃ − h₃₁vx − h₃₂ vy − v = 0 | (12) |

Those skill in the art can estimate distance using different homography matrices based on various camera characteristics. The homography matrix may be a linear transformation, but this invention may utilize other types of linear transformations or even nonlinear transformation methods. For example, the distortion at the edges and center of images captured by a fisheye lens differs, necessitating a nonlinear transformation method. Additionally, a lookup table (LUT) may be set up according to the characteristics of the lens. Therefore, this invention is not limited to transforming image coordinates into ground coordinates.

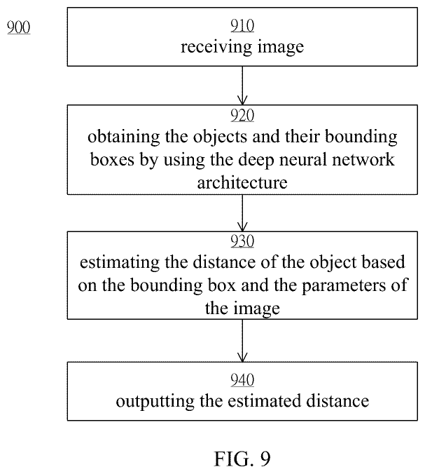

Please referring to FIG. 9, illustrates a flowchart of a method 900 for estimating object distance using images according to an embodiment of the invention. The method 900 for estimating object distance using images may be real-time, meaning that the execution time of the method 900 is limited. The method 900 begins with step 910.

Step 910: Receive an image. The image may be from the aforementioned camera on the vehicle.

Step 920: Use the deep neural network architecture provided by the invention to obtain the desired types of objects and their bounding boxes.

Step 930: Estimate the distance of the object based on the aforementioned bounding box and the parameters corresponding to the image. In one embodiment, the parameters corresponding to the image include a homography matrix. In other embodiment, the parameters corresponding to the image include a nonlinear function. Moreover, the parameters corresponding to the image include a lookup table.

Optional Step 940: Output the estimated distance. In one embodiment, the estimated distance may be output to the aforementioned navigation system, driving system, or safety system. The navigation system can plan an avoidance route. When used in a missile system, it can plan an impact trajectory. The driving system can perform corresponding driving behaviors to set the direction and speed, such as in an automatic cruise control system. The safety system can capture video footage or conduct further feature analysis of detected objects. For example, when someone approaches a door, the safety system can perform facial recognition to determine whether to open the door or raise an alarm.

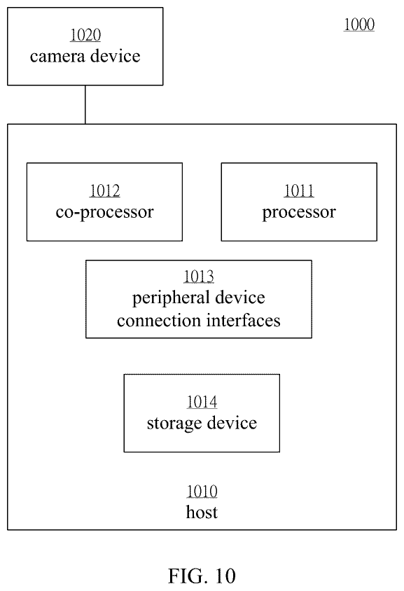

Please referring to FIG. 10, is a block diagram of a system for distance estimation using images in one embodiment of the invention. The system 1000 for distance estimation using images may be implemented inside a vehicle, and the aforementioned deep neural network architecture 100 can be implemented in the host 1010. In other words, the host 1010 can execute the method 900 for estimating the distance of objects using images or parts of its steps.

The host 1010 may include at least one processor 1011 for executing the operating system to control the host 1010 and/or the system 1000 for distance estimation using images. The processor 1011 may be an x86, x64, ARM, RISC-V, or other industrial standard instruction set processor. The operating system may be from the UNIX series, Windows series, Android series, iOS series, or other series of operating systems, and it can also be a real-time operating system.

The host 1010 may include one or more co-processors 1012 to accelerate the inference of the deep neural network architecture 100. The one or more co-processors 1012 may be graphics processing units (GPUs), neural network processing units (NPUs), artificial intelligence processing units (APUs), or other processors with multiple vector logic and arithmetic units to accelerate inference of the deep neural network architecture 100. The invention is not limited to the requirement that the host 1010 must have a co-processor 1012 to realize inference of the deep neural network architecture 100.

The host 1010 may includes peripheral device connection interfaces 1013 for connecting one or more camera devices 1020. The host 1010 may include a storage device 1014 for storing the aforementioned operating system and programs for implementing the deep neural network architecture 100. Those skilled in the art, possessing knowledge of computer organization, computer architecture, operating systems, system programs, artificial intelligence, and deep neural networks, can make variations or derivatives of the aforementioned host 1010 and the system 1000 for distance estimation using images, as long as they can implement the deep neural network architecture 100 provided by the present invention.

The camera device 1020 may be connected to the peripheral device connection interfaces of the host 1010 through industrial standard interfaces, such as common wired or wireless connection technologies like UWB, WiFi, Bluetooth, USB, IEEE 1394, UART, iSCSI, PCI-E, SATA, and other industrial standard technologies. The invention is not limited to the aforementioned industry standard interfaces, as long as the camera device 1020 can deliver image data at a rate sufficient to meet the real-time requirements of the distance estimation system 1000.

In one embodiment, the peripheral device connection interfaces 1013 may output the estimated distance to other devices or systems. The inference results of the deep neural network architecture 100 include one or more object bounding boxes to calculate the distance between the object and the camera device 1020. In another embodiment, the host 1010 may execute other programs to receive the estimated distance, as described in step 940.

To demonstrate that the deep neural network architecture 100 provided by this invention can perform well even in the computationally constrained environment of a vehicle, the applicant has implemented the deep neural network architecture 100 along with two other deep neural network architectures for performance comparison.

TABLE 3
Comparison of the deep neural network architecture 100
of this invention with other architectures

| | deep neural network | | |
|---|---|---|---|
| | architecture 100 | Yolov3-tiny | Yolofastestv2 |
| FLOPS | 0.12 G | 5.56 G | 0.11 G |
| number of detected | 53 | 51 | 46 |
| objects | | | |
| total error | 174 | 346 | 387 |
| average error | 3.28 | 6.78 | 8.41 |

Table 3 provides a performance comparison between the deep neural network architecture 100 proposed in this invention and two other architectures, Yolov3-tiny and Yolofastestv2. The floating-point operations of architecture 100 are comparable to those of Yolofastestv2 but significantly lower than those of Yolov3-tiny. This demonstrates that architecture 100 can be implemented in a lightweight computational environment.

In terms of object detection performance, architecture 100 detected 53 objects, more than the other two architectures. Regarding error, the applicant measures it by the pixel difference between the lower edge of the bounding box and the actual lower edge. The total error is the sum of errors for each detected object, and the average error per object represents the average error in distance estimation. The proposed architecture 100 in this invention demonstrates the best object detection rate and the lowest average pixel error. Specifically, architecture 100 improves the average error by 51.6% compared to Yolov3-tiny, while requiring 5.54 GFlops less computation. Compared to Yolofastestv2, which has similar computational requirements, architecture 100 shows a 61% improvement.

According to an embodiment of the invention, an object detection method is provided, comprising: receiving an image; and executing a deep neural network architecture based on the image to obtain one or more object bounding boxes, wherein the deep neural network architecture includes a two-dimensional discrete wavelet transform.

Preferably, to integrate information from deep and shallow networks, the deep neural network architecture comprises: a backbone network, comprising the two-dimensional discrete wavelet transform; a neck network, comprising a feature pyramid network, and configured to extract features from a transformation result of the two-dimensional discrete wavelet transform in the backbone network; and a detection head, configured to obtain the one or more object bounding boxes of one or more objects from the neck network.

Preferably, to detect objects of different scales, the detection head includes a large object detection head, a medium object detection head, and a small object detection head, each configured to obtain the one or more object bounding boxes from multiple chunks of different sizes in the neck network.

Preferably, to enhance the information of object edges or features, wherein the transformation result of the two-dimensional discrete wavelet transform includes a sum result of at least two of three results obtained by filtering with a high-pass filter of the two-dimensional discrete wavelet transform.

Preferably, to preserve the information of the original image, wherein the transformation result of the two-dimensional discrete wavelet transform comprises a concatenated result of the sum result and a result obtained without filtering by the high-pass filter of the two-dimensional discrete wavelet transform.

Preferably, to utilize a convolutional neural network for feature extraction, wherein the backbone network includes a convolutional neural network configured to obtain a convolution result, and the neck network includes a feature extraction result obtained by concatenating the transformation result with the convolution result from the backbone network.

According to an embodiment of the invention, a method for estimating distances of object using images is provided, comprising: performing the aforementioned object detection method; and using the one or more object bounding boxes and a corresponding parameter of the image to estimate a distance between one or more objects corresponding to the one or more object bounding boxes and a camera device that captured the image.

Preferably, to simplify the linear transformation for distance calculation, wherein the corresponding parameter of the image include a homography matrix, used to map one or more positions presented in the image to a ground.

According to an embodiment of the invention, a host for object detection is provided, comprising: one or more processors configured to execute multiple computer instructions stored in a non-volatile memory to implement the object detection method described above.

According to an embodiment of the present invention, a system for estimating distances of object using images is provided, comprising: a host including one or more processors configured to execute multiple computer instructions stored in a non-volatile memory to implement the method for estimating distances of the object using images as described above; and the camera device as described above.

According to the object detection method, method for estimating object distance from images, and its host and system provided by this invention, objects can be detected based on images, and the object bounding box can be stabilized, which enables more accurate distance estimation in post-processing. The feature of the invention lies in the provided deep neural network architecture that includes discrete wavelet transform, which can enhance object edges and features. Combined with the pyramid network as the feature neck network architecture, it can fuse the features presented by deep and shallow networks, enhance the object detection ability, and improve the complexity of the architecture, so that it does not require too many layers to achieve stable and accurate object bounding box detection, and also provides a faster inference time.

What is claimed is:

1. An object detection method, comprising:
receiving an image; and
executing a deep neural network architecture based on the image to obtain one or more object bounding boxes, wherein the deep neural network architecture includes a two-dimensional discrete wavelet transform.

2. The object detection method according to claim 1, wherein the deep neural network architecture comprises:
a backbone network, comprising the two-dimensional discrete wavelet transform;
a neck network, comprising a feature pyramid network, and configured to extract features from a transformation result of the two-dimensional discrete wavelet transform in the backbone network; and
a detection head, configured to obtain the one or more object bounding boxes of one or more objects from the neck network.

3. The object detection method according to claim 2, wherein the detection head includes a large object detection head, a medium object detection head, and a small object detection head, each respectively configured to obtain the one or more object bounding boxes from multiple chunks of different sizes in the neck network.

4. The object detection method according to claim 2, wherein the transformation result of the two-dimensional discrete wavelet transform comprises a sum result of at least two of three results obtained by filtering with a high-pass filter of the two-dimensional discrete wavelet transform.

5. The object detection method according to claim 4, wherein the transformation result of the two-dimensional discrete wavelet transform comprises a concatenated result of the sum result and a result obtained without filtering by the high-pass filter of the two-dimensional discrete wavelet transform.

6. The object detection method according to claim 2, wherein the backbone network includes a convolutional neural network configured to obtain a convolution result, and the neck network includes a feature extraction result obtained by concatenating the transformation result with the convolution result from the backbone network.

7. A method for estimating distances of object using images, comprising:
performing the object detection method according to claim 1; and
using the one or more object bounding boxes and a corresponding parameter of the image to estimate a distances between one or more objects corresponding to the one or more object bounding boxes and a camera device that captured the image.

8. The method for estimating distances of object using images according to claim 7, wherein the corresponding parameter of the image includes a homography matrix, used to map one or more positions presented in the image to a ground.

9. A host for object detection, comprising: one or more processors configured to execute multiple computer instructions stored in a non-volatile memory to implement the object detection method according to claim 1.

10. A system for estimating the distances of object using images, comprising:
a host including one or more processors configured to execute multiple computer instructions stored in a non-volatile memory to implement the method for estimating distances of the object using images as described in claim 7; and
the camera device as described in claim 7.
